(19) United States
(12) Patent Application Publication
(10) Pub. No.: US 2021/0117708 A1
(43) Pub. Date: Apr. 22, 2021

(54) METHOD FOR OBTAINING FACE DATA AND ELECTRONIC DEVICE THEREFOR

(71) Applicant: Samsung Electronics Co., Ltd., Gyeonggi-do (KR)

(72) Inventors: Tushar Balasaheb SANDHAN, Gyeonggi-do (KR); Juwoan YOO, Gyeonggi-do (KR); Wonsuk JANG, Gyeonggi-do (KR); Dasom LEE, Gyeonggi-do (KR)

(21) Appl. No.: 17/068,904

(22) Filed: Oct. 13, 2020

(30) Foreign Application Priority Data
Oct. 21, 2019 (KR) 10-2019-0130465

(51) Int. Cl. G06K 9/00; G06T 7/70; H04N 5/235; G01S 13/08

(52) U.S. Cl. CPC G06K 9/00899; G06T 7/70; H04N 5/2353; H04M 1/725; G06K 9/00288; G01S 13/08; G06T 2207/30201; G06K 9/00255

(57) ABSTRACT

Disclosed is an electronic device including a display, a camera, a wireless communication circuit connected to an antenna array including a plurality of antenna elements and configured to perform beamforming using the antenna array, a processor, and a memory. The processor may be configured to obtain an image including a face image via the camera, and obtain face data of a face corresponding to the face image via the wireless communication circuit.

### CROSS-REFERENCE TO RELATED APPLICATION(S)

This application claims the benefit under 35 U.S.C. § 119(a) of a Korean patent application filed on Oct. 21, 2019 in the Korean Intellectual Property Office and assigned Serial number 10-2019-0130465, the entire disclosure of which is hereby incorporated by reference.

### TECHNICAL FIELD

One or more embodiments of the present disclosure generally relate to a method for obtaining face data and an electronic device therefor.

### BACKGROUND

Personalized electronic devices such as mobile phones are widely used. For example, users may store sensitive information that needs to be secured in these electronic devices. With regard to security methods such as those that employ passwords or secret patterns, unauthorized persons may easily access personalized electronic devices if the corresponding security information (e.g. passwords) is exposed. Highly complicated passwords or patterns may be used in order to prevent security information from being leaked. In this case, users may experience difficulty in inputting the password or pattern due to the complexity of the password or pattern.

Biometric information may be used for securing electronic devices in order to achieve a high security level and ease of input. For example, electronic devices may authenticate users by recognizing fingerprints, irises, or faces of the user. More particularly, electronic devices may acquire an image of the face of a user, and may recognize the face based on features of the face image.

### SUMMARY

When recognizing a face using a face image, the electronic device may fail to recognize the face depending on the environment of the electronic device. For example, when the electronic device is in a dark environment, the electronic device may fail to obtain the face image. Furthermore, when recognizing a face, the electronic device may vulnerable to face image spoofing. For example, an unauthorized person may submit a photograph of the authorized user's face as the actual face of the authorized user. An electronic device vulnerable to this type of attach may erroneously recognize the photograph as the actual face of the user.

In order to prevent face image spoofing, the electronic device may determine whether the face image is of the actual face of a person. For example, the electronic device may perform liveness detection on the face image. For example, when the face image is recognized, the electronic device may measure the temperature of the object corresponding to the face image to determine whether the object is the face of the person or user. In another example, when the face image is recognized, the electronic device may measure the humidity of the object corresponding to the face image to determine whether the object is the face of the person. However, electronic devices such as mobile phones may not include such sensors.

An electronic device according to an embodiment of the present disclosure includes a display, a camera, a wireless communication circuit connected to an antenna array including a plurality of antenna elements and configured to perform beamforming using the antenna array, a processor operatively connected to the display, the camera, and the wireless communication circuit, and a memory operatively connected to the processor, wherein the memory stores one or more instructions that, when executed, cause the processor to obtain an image including a face image using the camera, and obtain face data of a face corresponding to the face image by controlling the wireless communication circuit based on the face image.

A method for an electronic device to obtain face data according to an embodiment of the present disclosure includes obtaining an image including a face image using a camera of the electronic device, controlling a wireless communication circuit of the electronic device based on the face image, and obtaining face data of a face corresponding to the face image using the wireless communication circuit. The wireless communication circuit may include an antenna array including a plurality of antenna elements configured to perform beamforming.

Additional aspects will be set forth in part in the description which follows and, in part, will be apparent from the description, or may be learned by practice of the presented embodiments.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to an embodiment.

FIG. 2 is a block diagram illustrating a camera module according to various embodiments.

FIG. 3 is a block diagram illustrating a communication circuit of an electronic device according to an embodiment.

FIG. 4 is a block diagram illustrating an electronic device according to an embodiment.

FIG. 5 illustrates a camera configuration of an electronic device according to an embodiment.

FIG. 6 illustrates beamforming using a communication circuit of an electronic device according to an embodiment.

FIG. 7 illustrates a camera control method based on a communication circuit of an electronic device according to an embodiment.

FIG. 8 illustrates a communication circuit control method based on a camera image of an electronic device according to an embodiment.

FIG. 9 illustrates a communication circuit control method based on a camera image of an electronic device according to an embodiment.

FIG. 10 illustrates a method for obtaining object data using a communication circuit of an electronic device according to an embodiment.

FIG. 11 is a flowchart illustrating a method for obtaining an image using a camera according to an embodiment.

FIG. 12 is a flowchart illustrating a method for obtaining face data using a communication circuit according to an embodiment.

FIG. 13 is a flowchart illustrating a liveness detection method according to an embodiment.

### DETAILED DESCRIPTION

Hereinafter, various embodiments of the present disclosure will be described with reference to the accompanying drawings. It should be understood that the embodiments and the terms used herein are not intended to limit the technology described in the present disclosure to specific embodiments, but rather include various modifications, equivalents and/or alternatives of the embodiments.

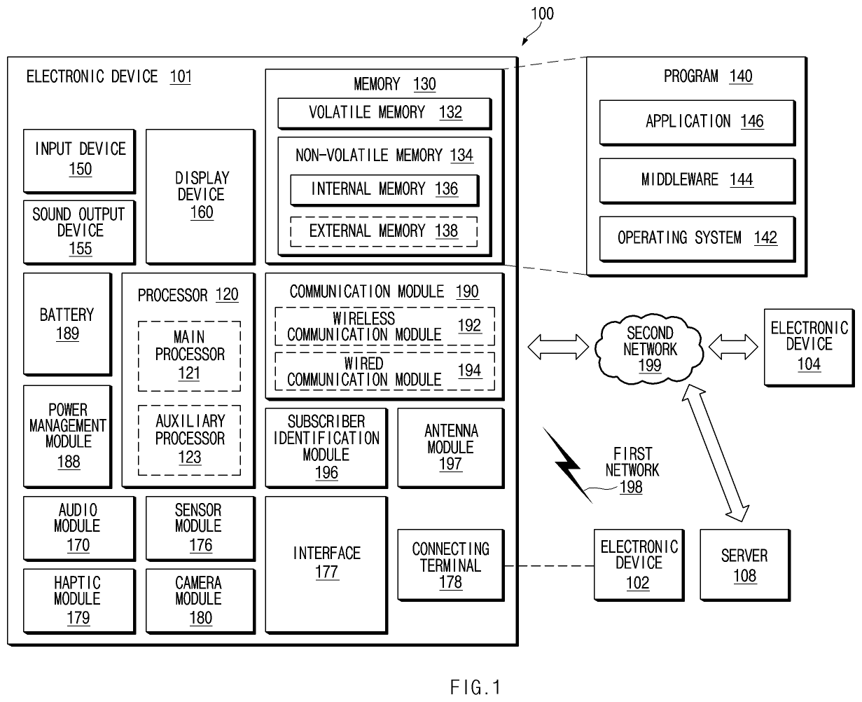

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

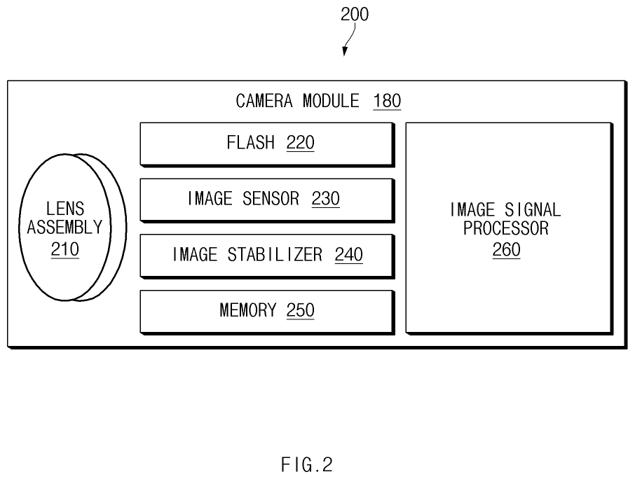

FIG. 2 is a block diagram 200 illustrating the camera module 180 according to an embodiment. Referring to FIG. 2, the camera module 180 may include a lens assembly 210, a flash 220, an image sensor 230, an image stabilizer 240, memory 250 (e.g., buffer memory), or an image signal processor 260. The lens assembly 210 may collect light emitted or reflected from an object whose image is to be taken. The lens assembly 210 may include one or more lenses. According to an embodiment, the camera module 180 may include a plurality of lens assemblies 210. In such a case, the camera module 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or the electronic device 101 including the camera module 180. This allows compensating for at least part of a negative effect (e.g., image blurring) by the movement on an image being captured. According to an embodiment, the image stabilizer 240 may sense such a movement by the camera module 180 or the electronic device 101 using a gyro sensor (not shown) or an acceleration sensor (not shown) disposed inside or outside the camera module 180. According to an embodiment, the image stabilizer 240 may be implemented, for example, as an optical image stabilizer.

The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display device 160. Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as a separate memory that is operated independently from the memory 130.

The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display device 160, the electronic device 102, the electronic device 104, or the server 108) outside the camera module 180. According to an embodiment, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display device 160 as it is or after being further processed.

According to an embodiment, the electronic device 101 may include a plurality of camera modules 180 having different attributes or functions. In such a case, at least one of the plurality of camera modules 180 may form, for example, a wide-angle camera and at least another of the plurality of camera modules 180 may form a telephoto camera. Similarly, at least one of the plurality of camera modules 180 may form, for example, a front camera and at least another of the plurality of camera modules 180 may form a rear camera.

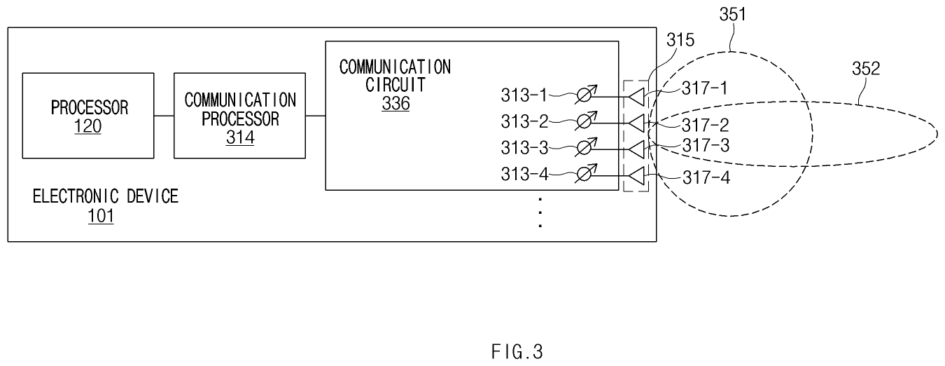

FIG. 3 is a block diagram illustrating a communication circuit 336 of an electronic device 101 according to an embodiment.

The electronic device 101 may further include various additional components not shown in FIG. 3, but, for concise description, FIG. 3 illustrates the electronic device 101 as including a processor 120, a communication processor 314, and the communication circuit 336. For example, the communication processor 314 and the communication circuit 336 may be configured as a single module.

In the illustrated embodiment, the communication circuit 336 may include first to fourth phase converters 313-1 to 313-4 and/or first to fourth antenna elements 317-1 to 317-4. The first to fourth antenna elements 317-1 to 317-4 may be respectively connected to the first to fourth phase converters 313-1 to 313-4. The first to fourth antenna elements 317-1 to 317-4 may form at least one antenna array 315.

According to an embodiment, the communication processor 314 may control the phases of signals transmitted and/or received through the first to fourth antenna elements 317-1 to 317-4 by controlling the first to fourth phase converters 313-1 to 313-4, and may generate a transmission beam and/or reception beam in a direction selected according to the control. Alternatively in another example, the communication processor 314 may transmit a signal using a transmission antenna array, and may receive a signal using a reception antenna array configured separately from the transmission antenna array.

According to an embodiment, the communication circuit 336 may generate a beam 351 having a wide radiation pattern (hereinafter referred to as a “wide beam”) or a beam 352 having a narrow radiation pattern (hereinafter referred to as a “narrow beam”) by operating the number of antenna elements. For example, the communication circuit 336 may form the narrow beam 352 using most of the plurality of antenna elements (e.g., three or more antenna elements in the first to fourth antenna elements 317-1 to 317-4), and may form the wide beam 351 using one or two of the plurality of antenna elements. The wide beam 351 may have a wider coverage than that of the narrow beam 352, but may have lower antenna gain. On the contrary, the narrow beam 352 may have a narrower coverage than that of the wide beam 351, but may have higher antenna gain.

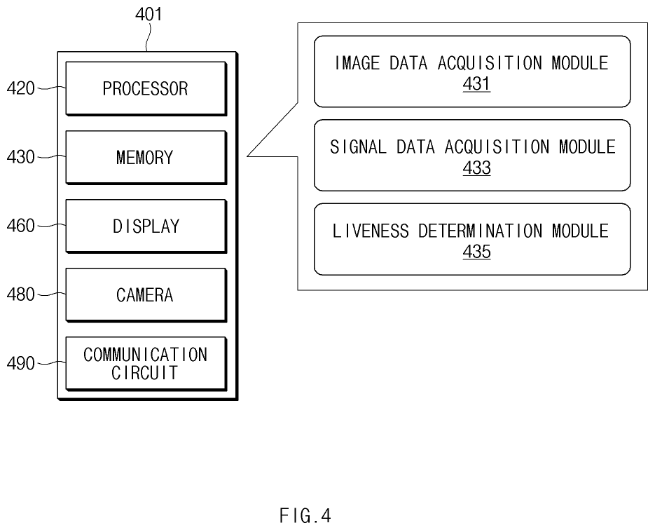

FIG. 4 is a block diagram illustrating an electronic device according to an embodiment.

According to an embodiment, an electronic device 401 (e.g., the electronic device 101 of FIG. 1) may include a processor 420 (e.g., the processor 120 (e.g., an application processor) and/or communication processor 314 of FIG. 3), a memory 430 (e.g., the memory 130 of FIG. 1), a display 460 (e.g., the display device 160 of FIG. 1), a camera 480 (e.g., the camera module 180 of FIG. 1), and a communication circuit 490 (e.g., the communication module 190 of FIG. 1 or the communication circuit 336 of FIG. 3). The configuration of the electronic device 401 illustrated in FIG. 4 is exemplary, and embodiments of the present disclosure are not limited thereto. For example, the electronic device 401 may not include at least one of the components illustrated in FIG. 4, in which case the image data acquisition module 431 and the signal data acquisition module 433, for example, may be integrated into a single module. In another example, the electronic device 401 may further include a component not illustrated in FIG. 4.

According to an embodiment, the processor 420 may be operatively connected to the memory 430, the display 460, the camera 480, and the communication circuit 490. The processor 420 may control the components (e.g., the memory 430, the display 460, the camera 480, and the communication circuit 490) of the electronic device 401. For example, the processor 420 may control the components of the electronic device 401 according to one or more instructions stored in the memory 430. The processor 420 may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Certain of the functions and steps provided in the Figures may be implemented in hardware, software or a combination of both and may be performed in whole or in part within the programmed instructions of a computer. No claim element herein is to be construed under the provisions of 35 U.S.C. § 112(f), unless the element is expressly recited using the phrase “means for.” In addition, an artisan understands and appreciates that a “processor” or “microprocessor” may be hardware in the claimed disclosure. Under the broadest reasonable interpretation, the appended claims are statutory subject matter in compliance with 35 U.S.C. § 101.

According to an embodiment, the processor 420 may obtain an image using the camera 480. The camera 480 may include a plurality of lenses. For example, the camera may obtain an image using at least a portion of the plurality of lenses. The camera 480 may be configured to obtain red/green/blue (RGB) data based on visible light. Alternatively, the camera 480 may be configured to obtain an image using infrared light.

According to an embodiment, the processor 420 may communicate with an external device using the communication circuit 490. For example, the communication circuit 490 may be configured to perform beamforming using an antenna array including a plurality of antenna elements. The communication circuit 490 may be configured to transmit/receive mmWave band signals. For example, the communication circuit 490 may transmit/receive signals according to Institute of Electrical and Electronics Engineers (IEEE) 802.ay standards. In another example, the communication circuit 490 may transmit/receive at least 6-GHz signals of the new radio (NR) communication protocol of 3^{rd} Generation Partnership Project (3GPP).

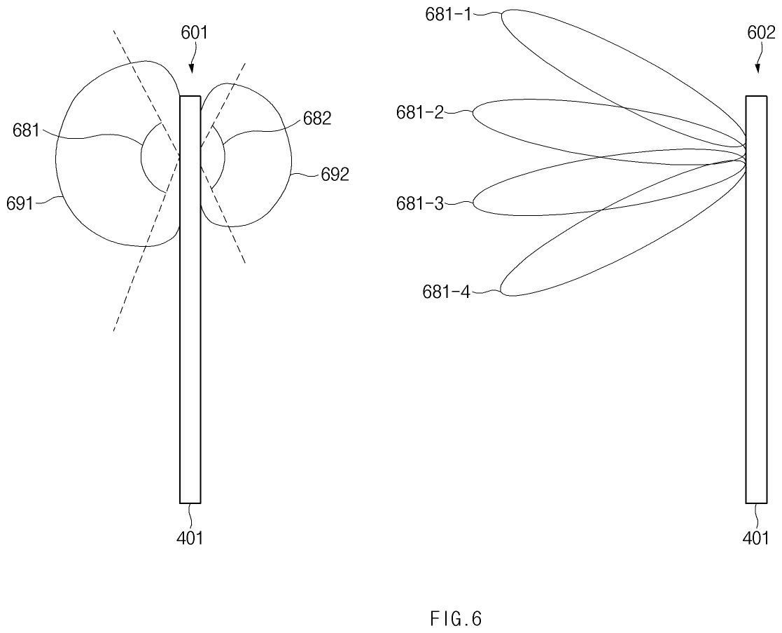

According to an embodiment, the processor 420 may obtain external object information (e.g., external object data) using the communication circuit 490. For example, the processor 420 may obtain the external object information by transmitting a signal and receiving or detecting a reflected signal that is the transmitted signal reflected from the external object. The external object information may include the distance to the external object, the shape, and/or movement of the external object. Certain embodiments for obtaining the external object information by using the communication circuit 490 may be described in reference to FIG. 6.

In the embodiments below, the external object information may be referred to as external object data obtained using the communication circuit 490. An external object image may be referred to as an image of the external object obtained using the camera 480. For example, when the external object is a face, the external object information may be referred to as face data, and the external object image may be referred to as a face image.

According to certain embodiments, the processor 420 may control the camera 480 based on the external object information. For example, the processor 420 may set a parameter of the camera 480 based on the external object information. More particularly in this example, the processor 420 may relatively quickly obtain the external object information by using the communication circuit 490 as compared to obtaining the external object information based on image analysis using images obtained by the camera 480. The processor 420 may capture an image of the external object using the camera 480 by setting the parameter of the camera 480 based on the external object information. In addition, in a situation (e.g., dark environment) in which it is difficult for the camera 480 to obtain the image of the external object, an image capture parameter of the camera 480 may be set using the external object information.

According to an embodiment, the processor 420 may obtain distance information about the external object using the communication circuit 490, and may control a parameter for focusing the camera 480 according to the distance information. The camera 480 may more quickly focus on the external object using the external object information as compared to when it has to perform auto focusing (AF) on the external object.

According to an embodiment, the processor 420 may control a shutter speed and/or exposure setting of the camera 480 based on the external object information. For example, when the movement of an external object indicated by the external object information is at least a specified first value, image blurring phenomenon may be prevented by increasing the shutter speed (e.g., reducing the exposure time) of the camera 480. When the movement of the external object indicated by the external object information is less than the specified second value, the processor 420 may reduce or set the shutter speed of the camera 480 to a specified value (e.g., a value according to an exposure setting of the camera 480).

According to an embodiment, when the processor 420 fails to recognize the external object from the image obtained using the camera 480 according to a set parameter, the processor 420 may adjust the parameter of the camera 480 using an automatic setting function (e.g., auto focusing, auto exposure adjustment) of the camera 480. For example, the automatic setting function may be performed by an image processor of the camera 480.

According to certain embodiments, the processor 420 may control the communication circuit 490 based on an external object image. When detecting an external object using the communication circuit 490, many attempts may be required since only limited information can be obtained by the communication circuit 490 due to characteristics of the communication circuit 490. For example, when using a wide beam (e.g., the wide beam 351 of FIG. 3) of the communication circuit 490, the electronic device 401 may be able to obtain only the distance information about the external object, and it may be difficult to obtain location information about the external object. In this case, the electronic device 401 may perform beam scanning which sequentially scans the environment using a plurality of beams (e.g., the narrow beam 353 of FIG. 3) in order to detect the external object. The time required for beam scanning is proportional to the number of beams output during the beam scanning. The processor 420 may obtain distance and location information about the external object to be detected using an external object image, and may use the distance and location information to quickly perform detection of the external object using the communication circuit 490.

According to an embodiment, the processor 420 may estimate the distance to the external object from an external object image. For example, the processor 420 may estimate the distance to the external object using distance estimation information (e.g., the size of the face image and/or distance between eyes of the face) that is present in the image of the external object. The processor 420 may detect the external object using information about a reflected signal corresponding to the estimated distance to the external object. For example, the processor 420 may receive a number of reflected signals in the time domain and may select the reflected signal received in a time interval corresponding to the distance to the external object determined from the external object image. The processor 420 may then use the selected reflected signal to detect the external object. In another example, the processor 420 may select a channel impulse response (CIR) tap for the reflected signal using the estimated distance to the external object. In this case, among all of the reflected signals, the processor 420 may detect the external object using data of the reflected signal corresponding to the selected tap. In these examples, it may be difficult for the processor 420 to determine which reflected signal among the received reflected signals corresponds to the external object. In these cases, the processor 420 may estimate, from the image of the external object, the distance to the external object to be detected so as to detect the external object using the communication circuit 490. Hereinafter, detection of the external object may include identification of the distance to the external object, the location of the external object, a movement of the external object, and/or a shape of the external object.

According to an embodiment, the processor 420 may estimate the location of the external object using the image of the external object, and may form a beam to the estimated location to detect the external object. For example, the processor 420 may determine, from the image of the external object, the location of the external object relative to the electronic device 401. The processor 420 may form at least one beam in the direction of the determined location using the communication circuit 490, and may detect the external location using the at least one formed beam.

According to certain embodiments, the processor 420 may determine the liveness of the corresponding face based on face image and face data. For example, the processor 420 may determine the liveness of the corresponding face by analyzing the face image and the face data using a machine learning model. In this example, the machine learning model may be stored in the memory of the electronic device 401 or may be externally obtained. The processor 420 may determine the liveness of the corresponding face using an image data acquisition module 431, a signal data acquisition module 433, and a liveness determination module 435. In this example, the image data acquisition module 431, the signal data acquisition module 433, and the liveness determination module 435 may be software modules implemented by the processor 420 and the memory 430.

According to an embodiment, the image data acquisition module 431 may obtain a face image using the camera 480. The image data acquisition module 431 may determine whether a face image is present in an image obtained using the camera 480, and, if the face image is present, may transfer the obtained image or face image to the liveness determination module 435. The liveness determination module 435 may determine whether the corresponding image is of an actual face of a person using a machine learning model. The liveness determination module 435 may generate a score about whether the corresponding image is an actual face of a person.

For example, the signal data acquisition module 433 may obtain face data using the communication circuit 490. The signal data acquisition module 433 may transfer the obtained face data to the liveness determination module 435. The liveness determination module 435 may determine whether the corresponding face data relates to an actual face of a person using a machine learning model. The liveness determination module 435 may generate a score about whether the corresponding face data is of an actual face of a person.

According to an embodiment, the processor 420 may determine whether a face in the face image is an actual face of a person based on the score for the face image and the score for face data. For example, the processor 420 may determine whether the corresponding face in the face image is an actual face of a person by adding up the two weighted scores. For example, the score for the face image may be s1 (e.g., a value between 0 and 1, which is set to be greater as the probability of an actual face of a person increases), and the score for face data may be s2 (e.g., a value between 0 and 1, which is set to be greater as the probability of an actual face of a person increases). In this case, the processor 420 may determine whether the corresponding face is an actual face of a person according to equation 1 below.

S=w1*s1+w2*s2 [Equation 1]

For example, weights w1 and w2 may be values between 0 and 1, and a sum of the weights w1 and w2 may be 1. The processor 420 may determine that the corresponding face is an actual face of a person if a score S is at least a specified threshold value.

According to an embodiment, the processor 420 may adjust the weights based on the environment of the electronic device 401. For example, in an environment in which reliability of the face image is low, the processor 420 may set the weight w1 for the face image-based score to a low value. More particularly, when the electronic device 401 is in a low-luminance environment, when a shaded region is present in the face image, or when there is glare in the face image, the processor 420 may set the weight for the face image-based score to a low value. In this case, the processor 420 may set the weight w2 for face data-based score to a relatively high value. In another example, in an environment in which reliability of face data is low, the processor 420 may set the weight w2 for the face data-based score to a low value. In this example, when the face is located at a short distance (e.g., within a specified distance) from the electronic device 401, the reliability of face data may be set to be low since face data from close faces may be similar to those of a spoofed face such as a picture image of the face. The processor 420 may determine whether the face is located a short distance away from the electronic device 401 based on the size of the face image or the distance between eyes in the face image. The processor 420 may set the weight w2 for the face data-based score to a lower value as the size of a face image increase or the distance between eyes increases. In this case, the processor 420 may set the weight w1 for the face image-based score to a relatively high value.

According to an embodiment, the processor 420 may perform user authentication based on the score for the face image and the score for face data. For example, even when the face image corresponds to a face of an authorized user, the processor 420 may refuse to authenticate the user if the face image is determined to be a fake face image (e.g., when the score S of equation 1 is less than a specified value). Alternatively, when the face image corresponds to the face of the authorized user is determined to be a genuine face image (e.g., when the score S of equation 1 is at least a specified value), the processor 420 may approve authentication of the user.

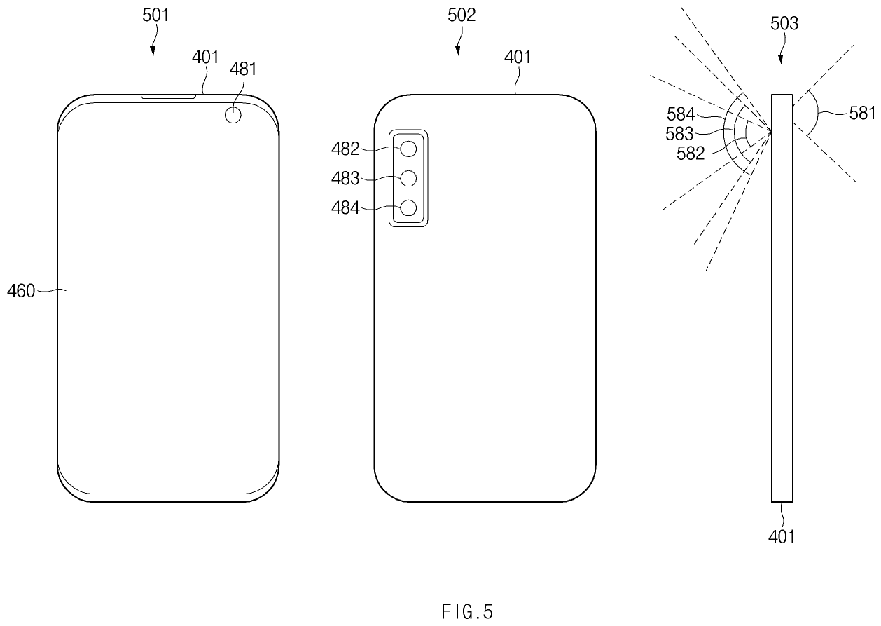

FIG. 5 illustrates a camera configuration of an electronic device according to an embodiment.

For example, the camera 480 may include a first camera 481, a second camera 482, a third camera 483, and a fourth camera 484. The configuration of the camera 480 illustrated in FIG. 4 is exemplary, and embodiments of the present disclosure are not limited thereto. For example, the camera 480 of the electronic device 401 may further include an infrared camera.

Referring to reference number 501, the first camera 481 may be positioned on a front surface (e.g., a surface on which the display 460 is positioned) of the electronic device 401. For example, the first camera 481 may be mounted in a form of a punch-hole in the display 460. In another example, the first camera 481 may be positioned under the display 460, and may be configured to obtain images through the display 460. In yet another example, the first camera 481 may be positioned in a region of the front surface of the electronic device 401 outside the display 460.

Referring to reference number 502, the second camera 482, the third camera 483, and the fourth camera 484 may be positioned on a rear surface (e.g., the reverse side of the surface on which the display 460 is positioned) of the electronic device 401.

Referring to reference number 503, the first camera 481, the second camera 482, the third camera 483, and the fourth camera 484 may have different viewing angles. For example, the first camera 481 may capture an image of an object in front of the electronic device 401 at a first viewing angle 581. The second camera 482, the third camera 483, and the fourth camera 484 may capture an image of an object in a rear of the electronic device 401. The second camera 482 may have a second viewing angle 582. The third camera 483 may have a third viewing angle 583. The fourth camera 484 may have a fourth viewing angle 584.

FIG. 6 illustrates beamforming using a communication circuit of an electronic device according to an embodiment.

Referring to reference number 601, the electronic device 401 may form a wide beam (e.g., the wide beam 351 of FIG. 3) using a communication circuit (e.g., the communication circuit 490 of FIG. 4), and may transmit/receive a signal using the wide beam. For example, a first lobe 691 may be a main lobe, and a second lobe 692 may be a back lobe. When the electronic device 401 forms a wide beam, the first lobe 691 and the second lobe 692 may have coverage at relatively wide angles. For example, the first lobe 691 may have a coverage of a first angle 681, and the second lobe 692 may have a coverage of a second angle 682.

According to an embodiment, the processor 420 may detect an external object using the communication circuit 490. For example, the processor 420 may detect an external object by transmitting a signal using the communication circuit 490 and receiving or detecting a reflected signal that is the transmitted signal reflected from the external object. The processor 420 may determine the distance between the electronic device 401 and the external object based on the time difference between the transmitted signal and the reflected signal and the phase difference between the transmitted signal and the reflected signal. For example, the processor 420 may detect the external object using a wide beam. Since the wide beam has wide coverage, the external object positioned within a relatively wide angle range may be detected. But since the wide beam has relatively low directivity, the electronic device 401 may determine the distance to the external object, but it may be difficult to determine the direction or location of the external object.

Referring to reference number 602, the electronic device 401 may generate a narrow beam (e.g., the narrow beam 353 of FIG. 3) using the communication circuit 490, and may transmit/receive a signal using the narrow beam. For example, the electronic device 401 may form beams oriented in various directions by changing phase and/or size of signals associated with a plurality of antenna elements of an antenna array. For example, the communication circuit 490 may form a first beam 681-1, a second beam 681-2, a third beam 681-3, and a fourth beam 681-4. The number and shape of the beams illustrated in FIG. 4 are exemplary, and embodiments of the present disclosure are not limited thereto. When the electronic device 401 forms a narrow beam, each of the beams 681-1 to 681-4 may have coverage of a relatively narrow angle.

According to an embodiment, the processor 420 may detect an external object using the communication circuit 490. For example, the processor 420 may detect the external object by forming a narrow beam using the communication circuit 490, transmitting a signal using the formed beam, and receiving or detecting a reflected signal that is the transmitted signal reflected from the external object. Since the narrow beam has a relatively high directivity compared to a wide beam, the processor 420 may determine the distance to the external object and the direction of the external object (e.g., a direction relative to the electronic device 401).

According to an embodiment, the processor 420 may obtain data associated with the external object using the communication circuit 490. For example, the data associated with the external object may include the distance to the external object, the shape of the external object, and/or the movement of the external object. According to an embodiment, the processor 420 may determine the distance to the external object based on the transmitted signal and the reflected signal. According to an embodiment, the processor 420 may obtain information about the shape of the external object by forming a beam in a region in which the external object is positioned and obtaining distance and direction information through a plurality of beams (e.g., a narrow beam). For example, the processor 420 may transmit a signal to the region of the external object using the first beam 681-1 and may receive a reflected signal using the first beam 681-1 to obtain first data. The processor 420 may transmit a signal to the region of the external object using the second beam 681-2 and may receive a reflected signal using the second beam 681-2 to obtain second data. The processor 420 may transmit a signal to the region of the external object using the third beam 681-3 and may receive a reflected signal using the third beam 681-3 to obtain third data. In this example, the processor 420 may generate the information about the shape of the external object using the first data, the second data, and the third data. According to an embodiment, the processor 420 may obtain movement information about the external object based on the phase difference between the transmitted signal and the received signal. For example, the processor 420 may obtain the movement information about the external object by detecting a phase shift due to the Doppler Effect.

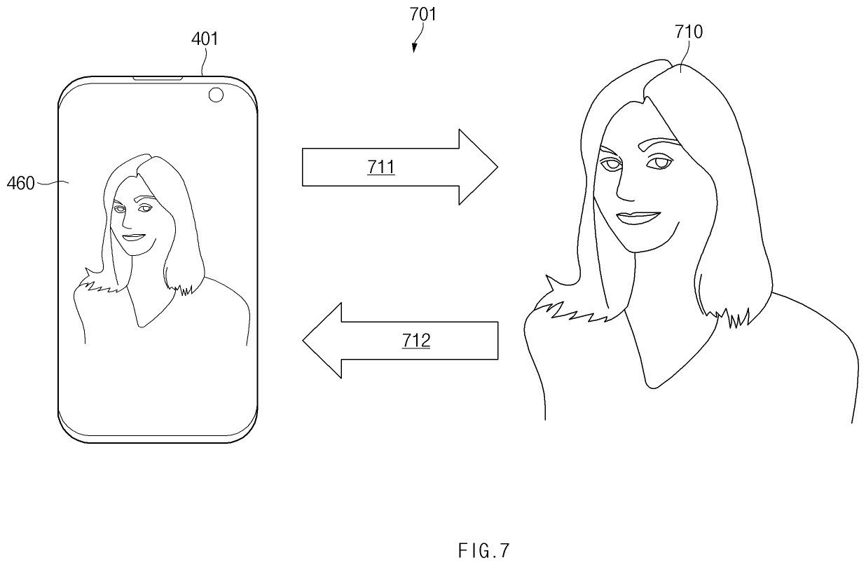

FIG. 7 illustrates a camera control method based on a communication circuit of an electronic device according to an embodiment.

Referring to FIG. 7, according to an embodiment, the processor 420 may obtain the distance information about an external object using the communication circuit 490, and may control the parameter for focusing the camera 480 according to the distance information. For example, the processor 420 may obtain the distance information about the external object 710 by transmitting a first signal 711 and receiving a second signal 712 reflected from the external object 710. The processor 420 may transmit the first signal 711 using a wide beam.

According to an embodiment, the processor 420 may control a shutter speed and/or exposure setting of the camera 480 based on the external object information. For example, when the movement of the external object detected by the second signal 712 is at least a specified first value, the processor 420 may increase the shutter speed (e.g., reduce an exposure time) of the camera 480.

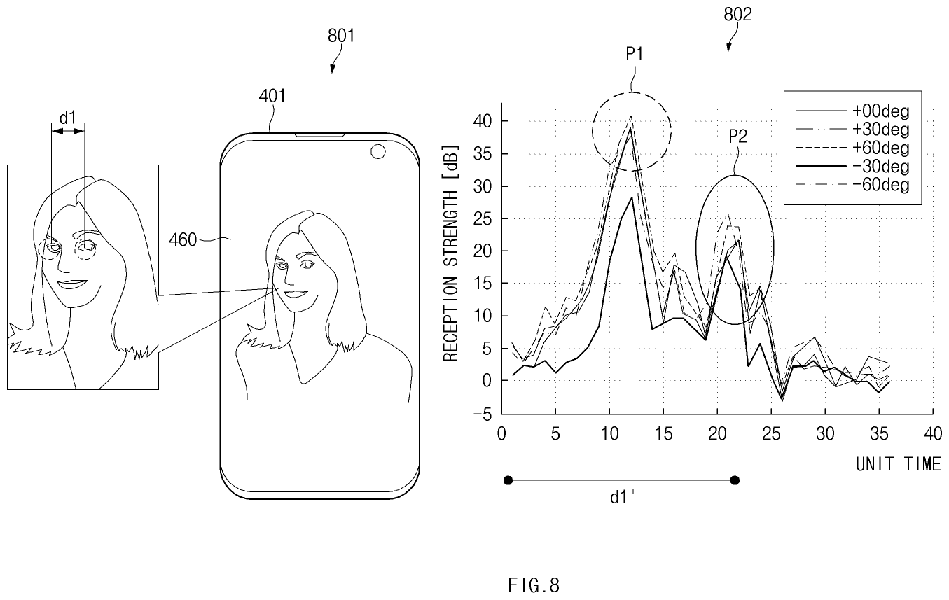

FIG. 8 illustrates a communication circuit control method based on a camera image of an electronic device according to an embodiment.

Referring to reference number 801, for example, the processor 420 may select a filter tap of the communication circuit 490 based on a distance d1 between eyes in a face image of an external object obtained using a camera (e.g., the camera 480 of FIG. 4). For example, the processor 420 may select a filter tap based on a correspondence relationship, which is stored in the memory 430, between the filter tap and the distance d1 between eyes.

Reference number 802 refers to a graph illustrating the received strength of a reflected signal per unit time. For example, the graph indicated by reference number 802 illustrates the strength of a reflected signal received by an antenna element in which a 0-degree phase is set, an antenna element in which a 30-degree phase is set, an antenna element in which a 60-degree phase is set, an antenna element in which a −30-degree phase is set, and an antenna element in which a −60-degree phase is set among the plurality of antenna elements of the communication circuit 490. For example, there may be a first peak P1 and a second peak P2. Therefore, in this case, external objects may be present in a location corresponding to the first peak P1 and in a location corresponding to the second peak P2. For example, the processor 420 may determine the second peak P2 that is closest to a filter tap d1′ corresponding to the distance d1 between eyes as the reflected signal corresponding to the external object to be detected. In this case, the processor 420 may set the filter tap of the communication circuit 490 to a filter tap within a specified range from the filter tap d1′, including the filter tap d1′. In another example, when a peak value (e.g., P2) is present within a specified range from the filter tap d1′, a filter tap within a specified range from the filter tap d1′, including the filter tap d1′, may be set as the filter tap of the communication circuit 490. When a peak value is not present within a specified range from the filter tap d1′, the processor 420 may receive the reflected signal using a maximum filter tap of the communication circuit 490.

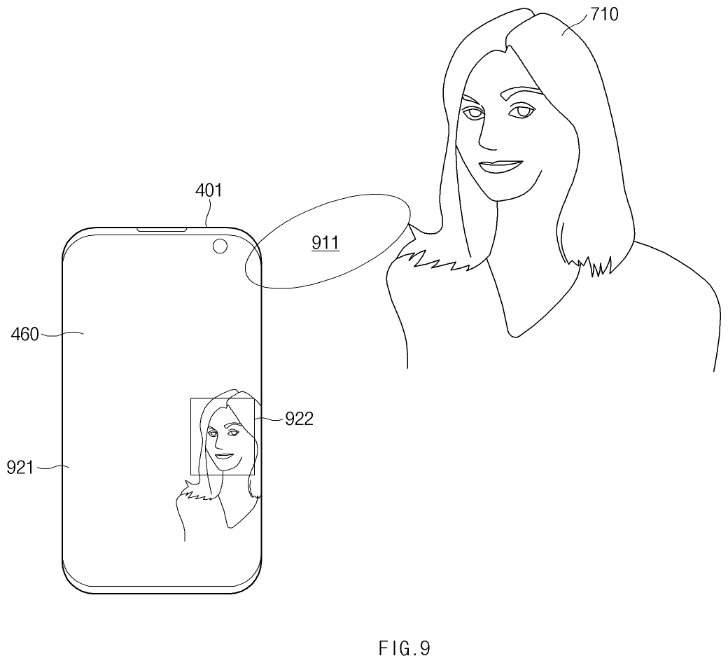

FIG. 9 illustrates a communication circuit control method based on a camera image of an electronic device according to an embodiment.

Referring to FIG. 9, according to an embodiment, the processor 420 may estimate the location of an external object using an image of the external object, and may form a beam to the estimated location to detect the external object. For example, from an image 921 obtained by the camera 480, a face region 922 on a right side of the image 921 may be identified. In this case, the processor 420 may determine that the face of the external object 710 is positioned on the right side of the electronic device 401. The processor 420 may form a beam 911 towards the right side of the electronic device 401 using the communication circuit 490, and may detect the external object 710 using the beam 911 (e.g., a narrow beam).

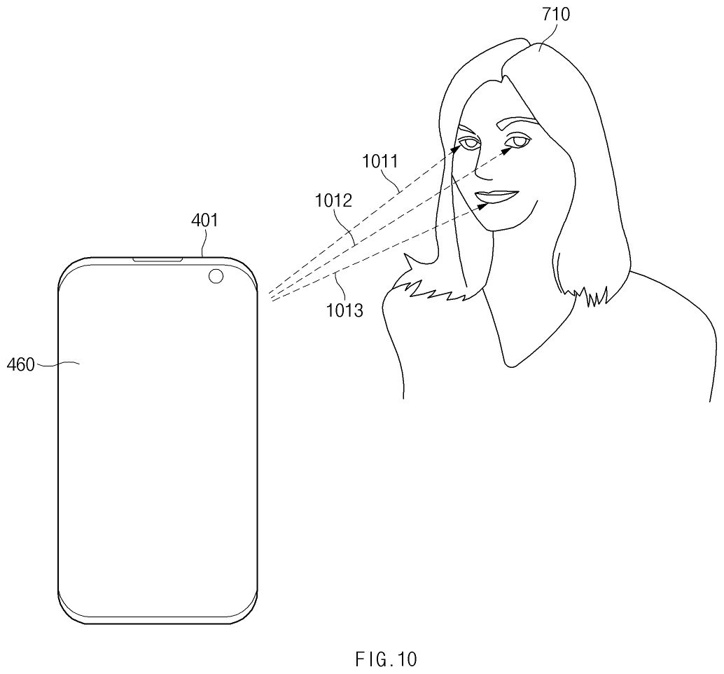

FIG. 10 illustrates a method for obtaining object data using a communication circuit of an electronic device according to an embodiment.

Referring to FIG. 10, the processor 420 may obtain data of the external object 710 using the communication circuit 490. For example, when the direction of the external object 710 is determined, the processor 420 may form a plurality of beams in the direction, and may obtain the data of the external object 710 using the plurality of beams (e.g., narrow beams). For example, the processor 420 may transmit a signal to the region of the external object 710 using a first beam 1011 and may receive a reflected signal using the first beam 1011 to obtain first data. Likewise, the processor 420 may obtain second data using a second beam 1012. The processor 420 may obtain third data using a third beam 1013. For example, the processor 420 may generate information about the shape of the external object 710 using the first data, the second data, and the third data. The processor 420 may obtain higher-resolution shape information about the external object 710 as the number of used beams increases.

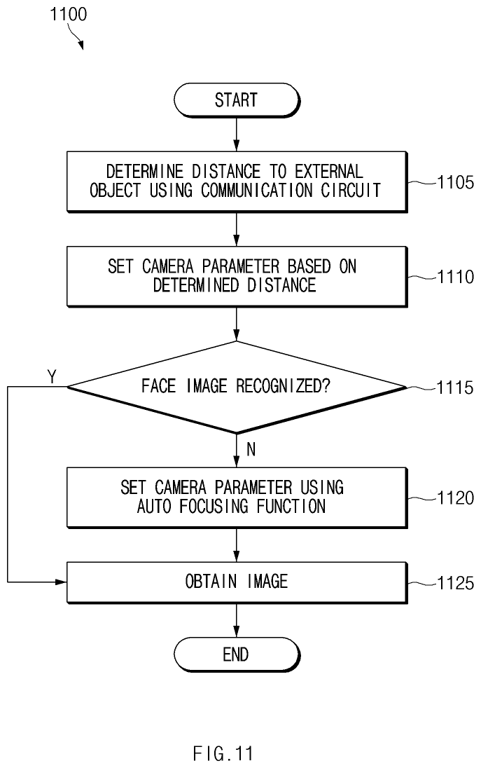

FIG. 11 is a flowchart 1100 illustrating a method for obtaining an image using a camera according to an embodiment.

Referring to FIG. 11, according to an embodiment, a processor (e.g., the processor 420 of FIG. 4) may determine the distance to an external object using a communication circuit (e.g., the communication circuit 490 of FIG. 4) in operation 1105. For example, the processor 420 may determine the distance to the external object by forming a wide beam using the communication circuit 490, transmitting a signal using the wide beam, and receiving a signal reflected from the external object.

According to an embodiment, in operation 1110, the processor 420 may set the parameter of the camera 480 based on the determined distance. For example, the processor 420 may set a parameter related to focusing of the camera 480 based on the determined distance. In operation 1110, the processor 420 may further set another parameter such as a shutter speed of the camera. For example, the processor 420 may detect a movement of the external object using the communication circuit 490, and may set a parameter associated with the shutter speed based on an amount of the movement.

According to an embodiment, in operation 1115, the processor 420 may determine whether a face image is recognized from an image obtained using the camera 480 according to the set parameter. For example, the processor 420 may obtain one or more images using the camera 480, and may attempt to recognize the face image using the one or more images. For example, the processor 420 may recognize the face image using image recognition based on a machine learning model.

According to an embodiment, when recognition of the face image has succeeded (e.g., operation 1115—Yes), in operation 1125, the processor 420 may obtain the image including the face image using the camera 480 having the parameter set according to operation 1110.

According to an embodiment, when recognition of the face image has failed (e.g., operation 1115—No), in operation 1120, the processor 420 may set a camera parameter using the auto focusing function of the camera 480. The processor 420 may set the camera parameter using another automatic setting function (e.g., auto exposure function) of the camera 480. In operation 1125, the processor 420 may obtain the image including the face image using the camera 480 configured with the parameter set according to operation 1120.

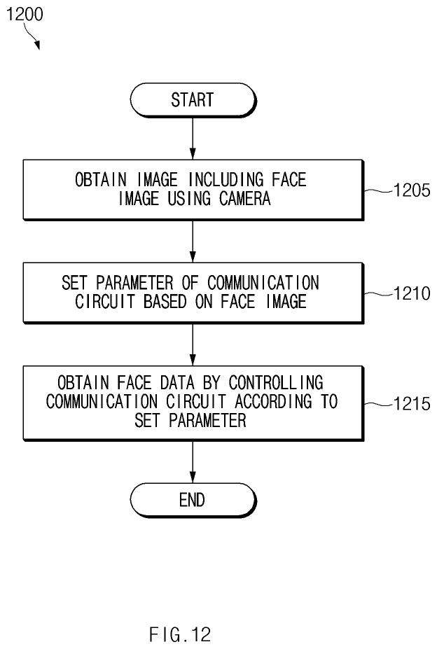

FIG. 12 is a flowchart 1200 illustrating a method for obtaining face data using a communication circuit according to an embodiment.

Referring to FIG. 12, according to an embodiment, a processor (e.g., the processor 420 of FIG. 4) may obtain an image including a face image using a camera (e.g., the camera 480 of FIG. 4) in operation 1205. For example, operation 1205 may correspond to operation 1125 of FIG. 11. In this case, operations 1210 and 1215 of FIG. 12 may be performed after operation 1125 of FIG. 11. However, in another example, operation 1205 may be performed regardless of operation 1125 of FIG. 11.

According to an embodiment, in operation 1210, the processor 420 may set a parameter of the communication circuit 490 based on the face image. For example, the processor 420 may set a filter tap and/or beamforming related parameter (e.g., phase information and/or gain information about antenna elements for beamforming) of a communication circuit (e.g., the communication circuit 490 of FIG. 4) based on the face image.

According to an embodiment, in operation 1215, the processor 420 may obtain face data by controlling the communication circuit 490 according to the set parameter.

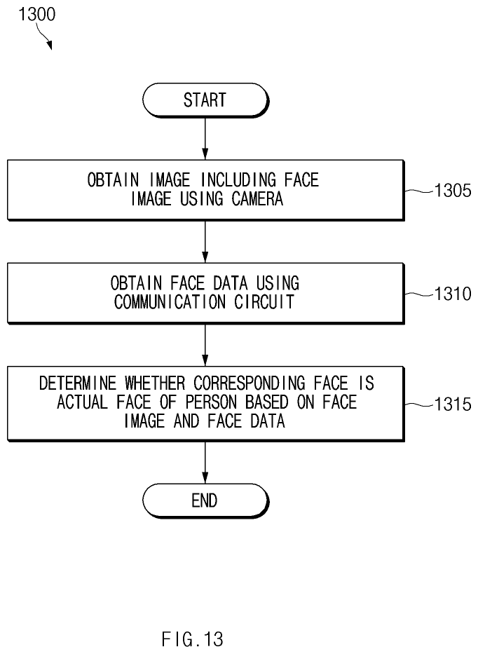

FIG. 13 is a flowchart 1300 illustrating a liveness detection method according to an embodiment.

Referring to the FIG. 13, according to an embodiment, a processor (e.g., the processor 420 of FIG. 4) may obtain an image including a face image using a camera (e.g., the camera 480 of FIG. 4) in operation 1305. For example, the processor 420 may obtain the face image according to the image acquisition method of FIG. 11. In another example, the processor 420 may obtain the face image according to an automatic setting function.

According to an embodiment, in operation 1310, the processor 420 may obtain face data using the communication circuit 490. For example, the processor 420 may obtain the face data according to the face data acquisition method of FIG. 12. According to an embodiment, operation 1310 may be performed before operation 1305.

According to an embodiment, the processor 420 may determine whether the corresponding face in the face image is an actual face of a person based on the face image and the face data in operation 1315. For example, the processor 420 may determine, based on the face image, a first value pertaining to whether the corresponding face is an actual face of a person. The processor 420 may determine, based on the face data, a second value pertaining to whether the corresponding face is an actual face of a person. The processor 420 may determine whether the corresponding face is an actual face of a person at least partially based on a sum of the first value and the second value. For example, the processor 420 may apply weights to the first value and the second value. The processor 420 may adjust the weights based on reliability of the face image and/or the face data.

According to an embodiment, an electronic device (e.g., the electronic device 401 of FIG. 4) may include a display (e.g., the display 460 of FIG. 4), a camera (e.g., the camera 480 of FIG. 4), a wireless communication circuit (e.g., the communication circuit 490 of FIG. 4) connected to an antenna array including a plurality of antenna elements and configured to perform beamforming using the antenna array, a processor (e.g., the processor 420 of FIG. 4) operatively connected to the display, the camera, and the wireless communication circuit, and a memory (e.g., the memory 430 of FIG. 4) operatively connected to the processor. The memory may store one or more instructions that, when executed, cause the processor to obtain an image including a face image using the camera, and obtain face data of a face corresponding to the face image by controlling the wireless communication circuit based on the face image.

For example, the one or more instructions, when executed, may cause the processor to form at least one beam using the wireless communication circuit based on a location of the face image in the image.

According to an embodiment, the one or more instructions, when executed, may cause the processor to determine a relative location of a user corresponding to the face relative to the electronic device based on the location of the face image in the image, and form the at least one beam towards the determined relative location.

According to an embodiment, the one or more instructions, when executed, may cause the processor to obtain the face data by transmitting a signal using the at least one beam and detecting a reflected signal of the transmitted signal.

According to an embodiment, the one or more instructions, when executed, may cause the processor to obtain a distance from the face to the electronic device using the wireless communication circuit, set a parameter associated with focusing of the camera based on the distance, and obtain the image including the face image using the camera in which the parameter is set.

According to an embodiment, the one or more instructions, when executed, may cause the processor to generate movement information about the face using the wireless communication circuit, set a parameter associated with a shutter speed of the camera based on the movement information, and obtain the image including the face image using the camera in which the parameter is set.

According to an embodiment, the one or more instructions, when executed, may cause the processor to determine whether the face is an actual face of a person based on the face image and the face data. For example, the one or more instructions, when executed, may cause the processor to calculate a first score of a probability that the face is the actual face of the person based on the face image, calculate a second score of the probability that the face is the actual face of the person based on the face data, and determine whether the face is the actual face of the person at least partially based on the first score and the second score. For example, the one or more instructions, when executed, may cause the processor to determine whether the face is the actual face of the person based on a sum of a first value obtained by applying a first weight to the first score and a second value obtained by applying a second weight to the second score. According to an embodiment, the one or more instructions, when executed, may cause the processor to adjust the first weight and the second weight based on at least one of a reliability of the image or a reliability of the face data.

A method for an electronic device to obtain face data according to an embodiment may include obtaining an image including a face image using a camera of the electronic device (e.g., operation 1305 of FIG. 13), controlling a wireless communication circuit of the electronic device based on the face image, and obtaining face data of a face corresponding to the face image using the wireless communication circuit (e.g., operation 1310 of FIG. 13). The wireless communication circuit may include an antenna array including a plurality of antenna elements configured to perform beamforming.

For example, the controlling of the wireless communication circuit of the electronic device based on the face image may include forming at least one beam using the wireless communication circuit based on a location of the face image in the image.

For example, the forming of the at least one beam using the wireless communication circuit may include determining a relative location of a user corresponding to the face relative to the electronic device based on the location of the face image in the image, and forming the at least one beam towards the determined relative location.

For example, the obtaining of the face data of the face corresponding to the face image using the wireless communication circuit may include transmitting a signal using the at least one beam and detecting a reflected signal of the transmitted signal to obtain the face data.

For example, the obtaining of the image including the face image using the camera of the electronic device may include obtaining a distance from the face to the electronic device using the wireless communication circuit, setting a parameter associated with focusing of the camera based on the distance, and obtaining the image including the face image using the camera in which the parameter is set.

For example, the obtaining of the image including the face image using the camera of the electronic device may include generating movement information about the face using the wireless communication circuit, setting a parameter associated with a shutter speed of the camera based on the movement information, and obtaining the image including the face image using the camera in which the parameter is set.

According to an embodiment, the method may further include determining whether the face is an actual face of a person based on the face image and the face data. For example, the determining whether the face is the actual face of the person based on the face image and the face data may include calculating a first score of a probability that the face is the actual face of the person based on the face image, calculating a second score of the probability that the face is the actual face of the person based on the face data, and determining whether the face is the actual face of the person at least partially based on the first score and the second score.

For example, the determining whether the face is the actual face of the person at least partially based on the first score and the second score may include determining whether the face is the actual face of the person based on a sum of a first value obtained by applying a first weight to the first score and a second value obtained by applying a second weight to the second score.

According to an embodiment, the method may further include adjusting the first weight and the second weight based on at least one of a reliability of the image or a reliability of the face data.

According to certain embodiments of the present disclosure, an electronic device may quickly obtain an image of an external object using a communication circuit.

According to certain embodiments of the present disclosure, an electronic device may obtain a face image by controlling a communication circuit using an image obtained by a camera.

According to certain embodiments of the present disclosure, an electronic device may provide a more robust face authentication method.

Certain of the above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

In addition, various effects may be provided that are directly or indirectly identified through the present disclosure.

While the present disclosure has been shown and described with reference to various embodiments thereof, it will be understood by those skilled in the art that various changes in form and details may be made therein without departing from the present disclosure as defined by the appended claims and their equivalents.

What is claimed is:

1. An electronic device comprising:
a display;
a camera;
a wireless communication circuit connected to an antenna array including a plurality of antenna elements and configured to perform beamforming using the antenna array;
a processor operatively connected to the display, the camera, and the wireless communication circuit; and
a memory operatively connected to the processor,
wherein the memory stores one or more instructions that, when executed, cause the processor to:
obtain, via the camera, an image including a face image; and
obtain, via the wireless communication circuit, face data of a face corresponding to the face image.

2. The electronic device of claim 1, wherein the one or more instructions, when executed, cause the processor to form at least one beam, via the wireless communication circuit, based on a location of the face image in the image.

3. The electronic device of claim 2, wherein the one or more instructions, when executed, cause the processor to determine a relative location of a user corresponding to the face relative to the electronic device based on the location of the face image in the image, and form the at least one beam towards the determined relative location.

4. The electronic device of claim 2, wherein the one or more instructions, when executed, cause the processor to obtain the face data by transmitting a signal via the at least one beam and detecting a reflected signal of the transmitted signal.

5. The electronic device of claim 1, wherein the one or more instructions, when executed, cause the processor to:
obtain a distance from the face to the electronic device via the wireless communication circuit;
set a parameter associated with focusing of the camera based on the distance; and
obtain the image including the face image via the camera in which the parameter is set.

6. The electronic device of claim 1, wherein the one or more instructions, when executed, cause the processor to:
generate movement information about the face via the wireless communication circuit;
set a parameter associated with a shutter speed of the camera based on the movement information; and
obtain the image including the face image via the camera in which the parameter is set.

7. The electronic device of claim 1, wherein the one or more instructions, when executed, cause the processor to determine whether the face is an actual face of a person based on the face image and the face data.

8. The electronic device of claim 7, wherein the one or more instructions, when executed, cause the processor to:
calculate a first score of a probability that the face is the actual face of the person based on the face image;
calculate a second score of the probability that the face is the actual face of the person based on the face data; and
determine whether the face is the actual face of the person at least partially based on the first score and the second score.

9. The electronic device of claim 8, wherein the one or more instructions, when executed, cause the processor to determine whether the face is the actual face of the person based on a sum of a first value obtained by applying a first weight to the first score and a second value obtained by applying a second weight to the second score.

10. The electronic device of claim 9, wherein the one or more instructions, when executed, cause the processor to adjust the first weight and the second weight based on a reliability of the image and/or a reliability of the face data.

11. A method for an electronic device to obtain face data, the method comprising:
obtaining, via a camera of the electronic device, an image including a face image;
controlling a wireless communication circuit of the electronic device based on the face image; and
obtaining face data of a face corresponding to the face image via the wireless communication circuit,
wherein the wireless communication circuit comprises an antenna array including a plurality of antenna elements configured to perform beamforming.

12. The method of claim 11, wherein the controlling of the wireless communication circuit of the electronic device based on the face image further comprises forming at least one beam via the wireless communication circuit based on a location of the face image in the image.

13. The method of claim 12, wherein the forming of the at least one beam via the wireless communication circuit further comprises:
determining a relative location of a user corresponding to the face relative to the electronic device based on the location of the face image in the image; and
forming the at least one beam towards the determined relative location.

14. The method of claim 12, wherein the obtaining of the face data of the face corresponding to the face image via the wireless communication circuit further comprises:
transmitting a signal via the at least one beam; and
detecting a reflected signal of the transmitted signal to obtain the face data.

15. The method of claim 11, wherein the obtaining of the image including the face image using the camera of the electronic device further comprises:
obtaining a distance from the face to the electronic device via the wireless communication circuit;
setting a parameter associated with focusing of the camera based on the distance; and
obtaining the image including the face image via the camera in which the parameter is set.

16. The method of claim 11, wherein the obtaining of the image including the face image using the camera of the electronic device further comprises:
generating movement information about the face via the wireless communication circuit;
setting a parameter associated with a shutter speed of the camera based on the movement information; and
obtaining the image including the face image using the camera in which the parameter is set.

17. The method of claim 11, further comprising determining whether the face is an actual face of a person based on the face image and the face data.

18. The method of claim 17, wherein the determining whether the face is the actual face of the person based on the face image and the face data comprises:
calculating a first score of a probability that the face is the actual face of the person based on the face image;
calculating a second score of the probability that the face is the actual face of the person based on the face data; and
determining whether the face is the actual face of the person at least partially based on the first score and the second score.

19. The method of claim 18, wherein the determining whether the face is the actual face of the person at least partially based on the first score and the second score comprises determining whether the face is the actual face of the person based on a sum of a first value obtained by applying a first weight to the first score and a second value obtained by applying a second weight to the second score.

20. The method of claim 19, further comprising adjusting the first weight and the second weight based on a reliability of the image and/or a reliability of the face data.
